(19) United States
(12) Patent Application Publication
(10) Pub. No.: US 2018/0204177 A1
(43) Pub. Date: Jul. 19, 2018

(54) Secure Automated Parcel Delivery

(71) Applicant: International Business Machines Corporation, Armonk, NY (US)

(72) Inventors: Jeffrey P. Ferla, Raleigh, NC (US); Clyde T. Foster, II, Raleigh, NC (US); Jhansi R. Kolla, Morrisville, NC (US); Joseph N. Kozhaya, Morrisville, NC (US); Karl D. McCormick, II, Raleigh, NC (US)

(21) Appl. No.: 15/408,515

(22) Filed: Jan. 18, 2017

(51) Int. Cl. G06Q 10/08; H04W 12/06; H04L 29/06

(52) U.S. Cl. CPC G06Q 10/0833; H04L 63/0876; H04W 12/06

(57) ABSTRACT

A mechanism is provided for secure automated parcel delivery. A first device owned and controlled by a recipient entity to whom a physical item is being delivered receives a delivery communication code. The recipient entity and through the first device determines a delivery policy data set indicative of a manner in which the physical item is to be delivered. Responsive to the detection that the physical item is being delivered to a designated delivery zone where the physical item will be received by the recipient entity, the first device wirelessly authenticates to a second. device controlled by a sender entity using the delivery communication code. Responsive to the authentication of the first device to the second device, the first device wirelessly communicates to the second device the delivery policy data set.

### BACKGROUND

The present application relates generally to an improved data processing apparatus and method for use in connection with parcel delivery and more specifically to mechanisms for secure automated parcel delivery.

Generally, parcel pick-up and delivery arrangements used to distribute parcels fundamentally operate on human interaction. For example, parcels are typically collected by a courier at a drop off location or scheduled for on-site pick-up. Information identifying the parcels and their destination is typically entered into a centralized tracking database by the courier or other personnel. The parcels are then transported to a distribution location (sometimes referred to as a node) for sorting, routing, and hand delivery to the intended destination. Delivery of the parcels again requires a courier to physically carry the parcel to the intended destination. If a parcel cannot be delivered to the destination, for example a home residence where none of the occupants are home at the time of delivery, the parcel must be couriered to a retention facility for later pick-up by the intended party or another delivery attempt must be scheduled.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for secure automated parcel delivery. The illustrative embodiment receives, by a first device owned and controlled by a recipient entity to whom a physical item is being delivered, a delivery communication code. The illustrative embodiment determines, by the recipient entity and through the first device, a delivery policy data set indicative of a manner in which the physical item is to be delivered. The illustrative embodiment detects, by the first device that the physical item is in the process of being delivered to a designated delivery zone where the physical item will be received by the recipient entity. The illustrative embodiment wirelessly authenticates the first device to a second device controlled by a sender entity using the delivery communication code via a third device in response to the detection that the physical item is being delivered. The illustrative embodiment wirelessly communicates, from the first device to the second device, the delivery policy data set in response to the authentication of the first device to the second device.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIG. 3 is an exemplary functional block diagram of a data processing system in which the secure automated parcel delivery mechanisms operates in accordance with an illustrative embodiment;

FIG. 4 depicts an exemplary flowchart of the operation performed by the secure automated parcel delivery mechanisms in preparing one or more physical items for secure automated parcel delivery in accordance with an illustrative embodiment; and

FIG. 5 depicts an exemplary flowchart of the operation performed by the secure automated parcel delivery mechanisms in delivering one or more physical items in accordance with an illustrative embodiment.

### DETAILED DESCRIPTION

Some embodiments of the present invention may recognize one, or more, of the following potential drawbacks, challenges and/or opportunities for improvement with respect to the state of the relevant art: (i) because of the need for couriers to physically travel to the point of pick-up and delivery, such arrangements are inherently inefficient in management of time and resources; (ii) this is particularly true because of the high rate of missed deliveries where the intended recipient was not present at the destination; (iii) for residential delivery, missed deliveries have become particularly problematic due to the ever increasing amount of shipping resulting from increased on-line purchasing of goods; (iv) hand delivery of parcels may pose significant risks to the safety of couriers who must sometimes travel to unsafe areas in order to pick-up or deliver parcels; and/or (v) some companies have made attempts to drop a parcel at the residence of the recipient only to have the parcel stolen by a thief.

Some embodiments of the present invention may recognize one, or more, of the following potential drawbacks, challenges and/or opportunities for improvement with respect to the state of the relevant art: (i) shipping schemes that use consolidated drop-off services that allow shipped parcels to be sent to a neutral drop-off site for subsequent pick-up by the intended party typically require recipients to be pre-registered and to specifically designate such delivery as part of the shipping instructions; (ii) in addition, unique PIN-type authentication arrangements are typically employed in order to authenticate the intended party at the time of parcel pick-up, but such PIN-type arrangements tend to be inconvenient, as well as add to the overall complexity of maintaining the system as a result of the need to assign and manage the unique PIN numbers; and/or (iii) PIN-type authentication arrangements may present certain risks and additional costs relating to liability for the shipped parcels while being held for pick-up.

The illustrative embodiments provide mechanisms for secure automated parcel delivery. As noted above, various parcel delivery services leave parcels at the delivery address, attempt to deliver a. parcel only to have to return to the address later due to the recipient not being at the address at the time of the initial attempt, or ship the parcel to a neutral drop-off site for subsequent pick-up by the intended party, all of which have various deficiencies. To improve the efficiency and speed of delivering parcels, retailers and shipping companies are currently experimenting with automated parcel delivery systems, such as drones. However, as with couriers, drone delivery has the inherent risk of having a parcel dropped off by the drone absconded with by a thief.

Thus, the illustrative embodiments provide secure automated parcel delivery mechanisms that address the problem of secure parcel delivery from retailers to recipients. Specifically, in the context of leveraging courier, drone, or similar types of parcel delivery mechanisms, the illustrative embodiments provide for secure automated parcel delivery through the use of a secure receiving device located at the recipient's location that allows for secure automated parcel delivery and either eliminates or greatly reduces having to return to the location if the recipients are not home, leaving a parcel at the location only for it to be absconded with by a thief, or the like. By either eliminating or greatly reducing these events, the secure automated parcel delivery mechanisms of the illustrative embodiments reduce associated costs, maximize retailers' profit, and improve overall customer experience.

Some embodiments of the present invention may include one, or more, of the following characteristics, features, advantages and/or operations: (i) receiving, by a first device owned and controlled by a recipient entity to whom a physical item is being delivered and from a second device controlled by a sender entity who is sending the physical item, a delivery communication code; (ii) determining, by the recipient entity and through the first device, a delivery policy data set indicative of a manner in which the physical item is to be delivered; (iii) detecting that the physical item is in the process of being delivered to a designated delivery zone where it will be received by the recipient entity; (iv) responsive to the detection that the physical item is being delivered, wirelessly authenticating the first device to a third device and/or a second device controlled by the sender entity using the delivery communication code; (v) responsive to the authentication, wirelessly communicating, from the first device to the third device (the second and third device may, or may not, he the same device), the delivery policy data set; (vi) the delivery communication code further includes information indicative of the identity of the physical item; (vii) the manner in which the physical item is to be delivered is at least one of the following: recipient entity defines groceries to be delivered into refrigerated compartment, recipient entity defines medication policy of being delivered to recipient entity only, recipient entity sets time window for delivery, recipient entity specifies acknowledgement policy for package receipt, and/or recipient entity specifies multiple entities to receive different portions of the physical item being delivered; (viii) machine learning of preferred delivery policies for different products based on various parameters including customer, location, product, etc.; and/or (ix) defining a policy-based delivery of parcels where recipient can control several aspects of the delivery policy including setting time window for delivery, preferred location for delivery (at home or away), and security protocol for delivery.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. h will be apparent to those of ordinary skill in the art in view of the present description that there are many other alternative implementations for these various elements that may be utilized in addition to, or in replacement of, the examples provided herein without departing from the spirit and scope of the present invention.

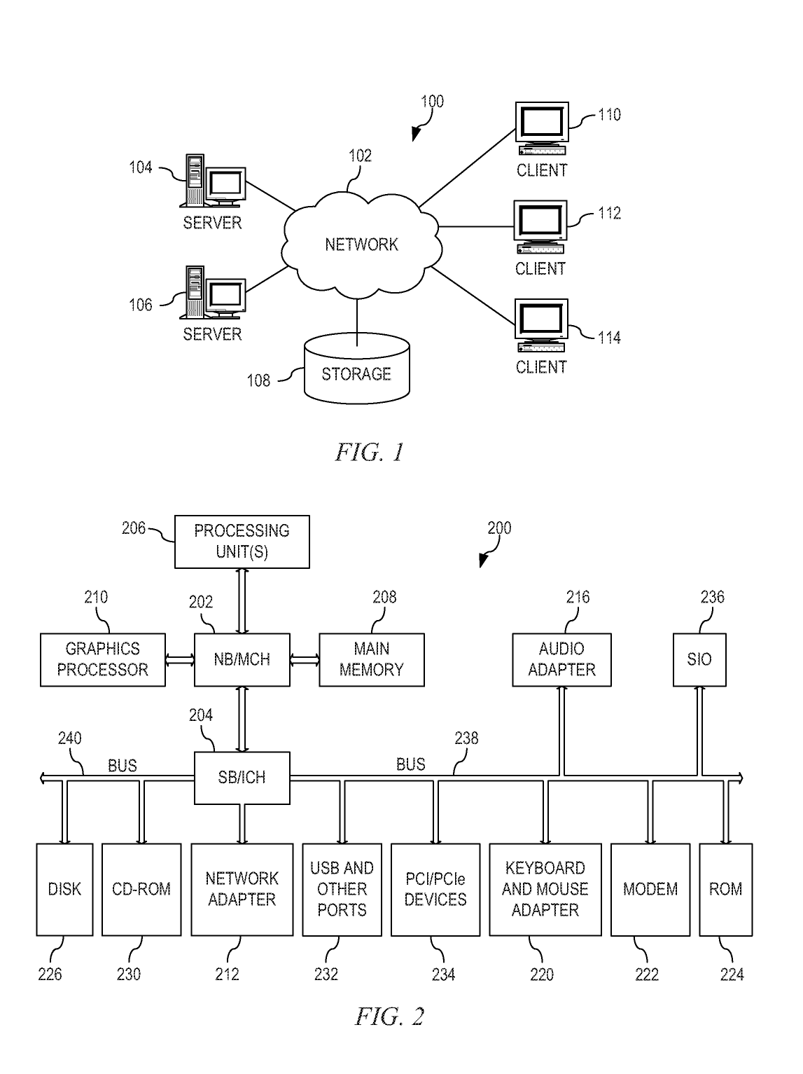

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

As shown in FIG. 1, one or more of the computing devices, e.g., server 104, may be specifically configured to implement secure automated parcel delivery mechanisms. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates secure automated parcel delivery.

As noted above, the mechanisms of the illustrative embodiments utilize specifically configured computing devices, or data processing systems, to perform the operations for secure automated parcel delivery. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed so as to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, Power™ processor based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter with regard to the secure automated parcel delivery.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

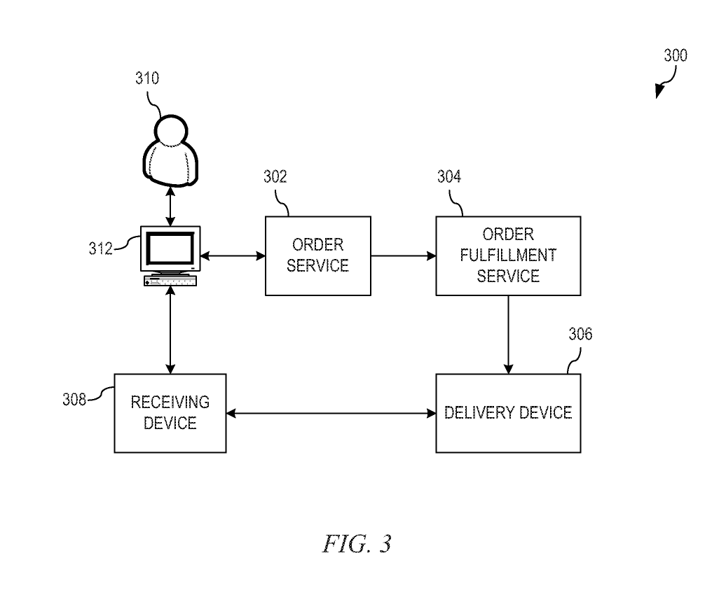

FIG. 3 is an exemplary functional block diagram of a data processing system in which the secure automated parcel delivery mechanisms operates in accordance with an illustrative embodiment. Data processing system 300, which is a data processing system such as data processing system 100 of FIG. 1, comprises order service 302, order fulfillment service 304, delivery device 306, and receiving device 308. In operation, order service 302 receives, as part of a purchase process, a selection of one or more physical items to be purchased by buyer 310 via client device 312 as well as information (i.e. a delivery policy data set indicative of a manner in Which the physical item is to be delivered) for completing the order, such as an address where the one or more physical items are to be delivered, contact information if issues arise with completing the order, payment information to pay for the one or more physical items, a type of wireless communication to be used in delivery of the one or more physical items, a time window for delivery of the one or more physical items, an acknowledgement policy for receipt of the one or more physical items, multiple addresses to receive different portions of the one or more physical items, or the like. The one or more physical items may include groceries to be delivered into refrigerated compartment, medications to be delivered, or the like.

When the order of the one or more physical items is complete and payment confirmed, order service 302 generates a confirmation communication that includes an identification of the one or more purchased physical items and a delivery communication code, such as an electronic secure key, digitally encrypted key, or the like, utilized for secure automated parcel delivery. The delivery communication code has a predetermined active life based on expected delivery date/time associated with the one or more purchased physical items purchased by buyer 310. If the one or more purchased physical items are to be delivered all at one time, then order service 302 generates one delivery communication code that is sent to buyer 310. However, if one or more of the one or more purchased physical items have separate expected delivery dates/times, then order service 302 may generate multiple delivery communication codes, one for each group of items with different expected delivery dates/times, and send the multiple delivery communication codes to buyer 310. Furthermore, if one or more of the one or more purchased physical items has its expected delivery date/time changed during order processing, order service 302 may issue a new delivery communication code associated with the new expected delivery date time and send the new delivery communication code to buyer 310. When sending the new delivery communication code, order service 302 may also deactivate any previously sent delivery communication codes that would no longer be valid due to the change in the expected delivery date/time. Basically, the delivery communication code is only active for a predetermined time period around the expected delivery date/time.

Order service 302 sends the delivery communication code to client device 312 as part of the confirmation communication, which may be displayed on a display of client device, incorporated within an email or text confirmation, or the like. As part of the secure automated parcel delivery, the delivery communication code may be relayed to buyer 310 via client device 312. In one embodiment, the delivery communication code is kept in client device 312 while in another embodiment, the delivery communication code is further relayed by client device 312 to receiving device 308 for use in the secure automated parcel delivery, which will be described in detail hereafter. Client device 312 may relay the delivery communication code to receiving device 308 using any one of a number of wireless communication methods, such as near field communication, Bluetooth communication, Wi-Fi communications, Bluetooth Low Energy (BTLE), or the like. Typically, the type of wireless communication used to communicate between client device 312 and receiving device 308 will be the same type of wireless communication used by delivery device 306 when the one or more purchased physical items are delivered to receiving device 308. In one embodiment, client device 312 and receiving device 308 may be a same device.

In addition to sending the delivery communication code to client device 312 as part of the confirmation communication, order service 302 may also send the delivery communication code to order fulfillment service 304 along with other pertinent information, such as an identification of the one or more purchased physical items, the address where the one or more physical items are to be delivered, contact information for contacting buyer 310 if issues arise with completing the order, the type of wireless communication to be used in delivery of the one more purchased items, or the like. Therefore, when the one or more purchased physical items are ready for shipping, order fulfillment service 304 programs delivery device 306 with the address where the one or more physical items are to be delivered, the type of wireless communication to be used in delivery of the one more purchased items, and the delivery communication code. In accordance with the illustrative embodiments, delivery device 306 may be a drone, may be delivery information acquisition device, power pad, or the like

Once delivery device 306 is within a predetermined distance, i.e. a physical proximity, of the address where the one or more physical items are to be delivered, delivery device 306 initiates a connection to receiving device 308 using the type of wireless communication to be used in delivery of the one more purchased items, such as near field communication, Bluetooth communication, Wi-Fi communications, or the like. Once delivery device 306 establishes a connection to receiving device 308, a secure connection is established using the delivery communication code for certification. That is, using the delivery communication code within client device 312 and/or receiving device 308, delivery device 306 and receiving device 308 and/or client device 312 confirm that the delivery communication code in receiving device 308 and/or client device 312 matches the delivery communication code in delivery device 306. Once the secure connection is established, receiving device 308 and/or client device 312 provide details to delivery device 306 as to an exact location of receiving device 308. That is, receiving device 308 is at a location on the property associated with the address where the one or more physical items are to be delivered, the location being, for example, front of house, back of house, side next to garage, on a patio, or some other location on the property that is accessible by delivery device 306. Thus, receiving device 308 guides delivery device 306 to the exact location of receiving device 308.

In accordance with the illustrative embodiments, receiving device 308 is a secure device that is normally locked. Thus, receiving device 308 performs one or more actions to receive the one or more purchased physical items once secure communications are established with delivery device 306. One example, receiving device 308 simply unlocks so that, if delivery device 306 is a handheld device used by a courier, the courier with delivery device 306 in hand, opens receiving device 308, places the one or more purchased physical items inside receiving device 308, and closes receiving device 308. Once receiving device 308 is closed, receiving device 308 performs a locking action so as to securely hold the one or more purchased physical items. In another example, receiving device 308 unlocks and utilizes an opening mechanism to open so that the one or more purchased physical items may be placed inside. That is, if delivery device 306 is a drone, then once receiving device 308 unlocks and opens, delivery device 306 may drop or otherwise place the one or more purchased physical items inside. Once receiving device 308 detects or is informed that the one or more purchased physical items are inside, receiving device 308 reverses the opening mechanism so that receiving device 308 closes and then performs a locking action so as to securely hold the one or more purchased physical items. In either example, receiving device 308 may utilize one or more sensors, cameras, or the like, to determine that the one or more purchased physical items have indeed been placed within receiving device 308 so as to protect buyer 310 from a fraudulent delivery as well as to protect order fulfillment service 304. A combination of checks may be applied to compare the weight of the item or items, the physical shape of the item, as well as radio-frequency identification (RFID) tag on the object to confirm the correct package is being delivered. The properties of the delivered package may be communicated between the client receiving device and the delivery device upon establishing secure connection or they could be communicated much earlier together with delivery code when the purchase was completed. Once receiving device 308 completes the one or more actions to protect the one or more purchased physical items, receiving device 308 and/or delivery device 306 may confirm delivery of the one or more purchased physical items and deactivate the delivery communication code associated with the one or more purchased physical items.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission Fibers, wireless transmission, routers, firework, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

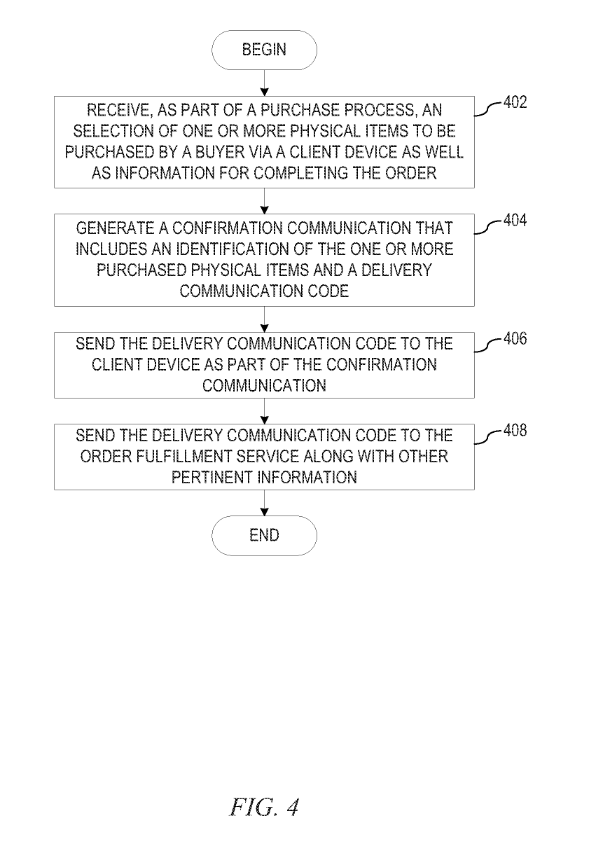

FIG. 4 depicts an exemplary flowchart of the operation performed by the secure automated parcel delivery mechanisms in preparing one or more physical items for secure automated parcel delivery in accordance with an illustrative embodiment. As the operation begins, an order service receives, as part of a purchase process, a selection of one or more physical items to be purchased by a buyer via a client device as well as information for completing the order (step 402), such as an address where the one or more physical items are to be delivered, contact information if issues arise with completing the order, payment information to pay for the one or more physical items, a type of wireless communication to be used in delivery of the one or more physical items, a time window for delivery of the one or more physical items, an acknowledgement policy for receipt of the one or more physical items, multiple addresses to receive different portions of the one or more physical items, or the like. The one or more physical items may include groceries to be delivered into refrigerated compartment, medications to be delivered, or the like.

When the order of the one or more physical items is complete and payment is confirmed, the order service generates a confirmation communication that includes an identification of the one or more purchased physical items and a delivery communication code (step 404), such as an electronic secure key, digitally encrypted key, or the like, utilized for secure automated parcel delivery. The delivery communication code has a predetermined active life based on expected delivery date/time associated with the one or more purchased physical items purchased by the buyer. If the one or more purchased physical items are to be delivered all at one time, then the order service generates one delivery communication code that is sent to the buyer. However, if one or more of the one or more purchased physical items have separate expected delivery dates/times, then the order service may generate multiple delivery communication codes, one for each group of items with different expected delivery dates/times, and send the multiple delivery communication codes to buyer. Furthermore, if one or more of the one or more purchased physical items has its expected delivery date/time changed during order processing, the order service may issue a new delivery communication code associated with the new expected delivery date time and send the new delivery communication code to the buyer. When sending the new delivery communication code, the order service may also deactivate any previously sent delivery communication codes that would no longer be valid due to the change in the expected delivery date/time. Basically, the delivery communication code is only active for a predetermined time period around the expected delivery date/time.

The order service then sends the delivery communication code to the client device as part of the confirmation communication (step 406), which may be displayed on a display of client device, incorporated within an email or text confirmation, or the like. As part of the secure automated parcel delivery, the delivery communication code may be relayed to the buyer via the client device. In one embodiment, the delivery communication code is kept in the client device while, in another embodiment, the delivery communication code is further relayed by the client device to the receiving device for use in the secure automated parcel delivery, which will be described in detail hereafter. The client device may relay the delivery communication code to the receiving device using any one of a number of wireless communication methods, such as near field communication, Bluetooth communication, Wi-Fi communications, Bluetooth Low Energy (BTLE) or the like. Typically, the type of wireless communication used to communicate between the client device and the receiving device will be the same type of wireless communication used by the delivery device when the one or more purchased physical items are delivered to the receiving device.

In addition to sending the delivery communication code to the client device as part of the confirmation communication, the order service may also send the delivery communication code to the order fulfillment service along with other pertinent information (step 408), such as an identification of the one or more purchased physical items, the address where the one or more physical items are to be delivered, contact information for contacting the buyer if issues arise with completing the order, the type of wireless communication to be used in delivery of the one more purchased items, or the like. The operation ends thereafter.

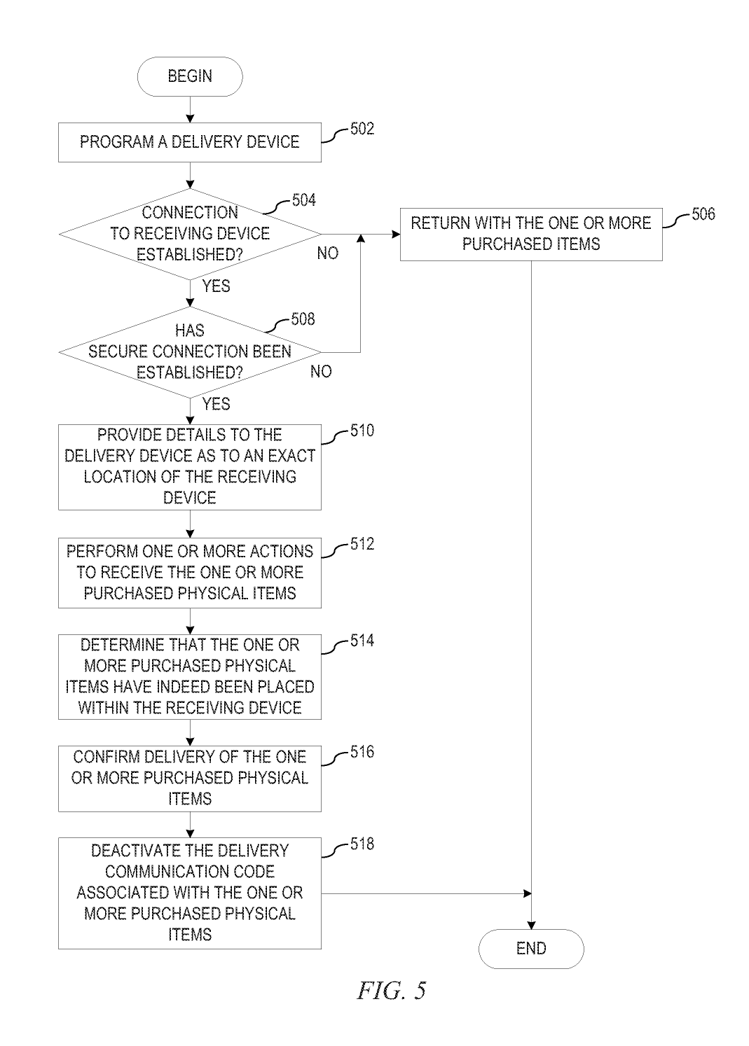

FIG. 5 depicts an exemplary flowchart of the operation performed by the secure automated parcel delivery mechanisms in delivering one or more physical items in accordance with an illustrative embodiment. As the operation begins, when the one or more purchased physical items are ready for shipping, the order fulfillment service programs a delivery device (step 502) with the address where the one or more physical items are to be delivered, the type of wireless communication to be used in delivery of the one more purchased items, and the delivery communication code. In accordance with the illustrative embodiments, delivery device 306 may be a drone, may be delivery information acquisition device, power pad, or the like.

Once the delivery device is within a predetermined distance, i.e. a physical proximity, of the address where the one or more physical items are to be delivered, the delivery device initiates a connection to the receiving device (step 504) using the type of wireless communication to be used in delivery of the one more purchased items, such as near field communication, Bluetooth communication, Wi-Fi communications, or the like. If at step 504, the delivery device is not able to establish a connection to the receiving device, then the delivery device returns with the one or more purchased items (step 506), with the operation ending thereafter.

If at step 504 the delivery device establishes a connection to the receiving device, the delivery device establishes a secure connection using the delivery communication code for certification (step 508). That is, using the delivery communication code within the client device and/or the receiving device, the delivery device and the receiving device and/or the client device confirm that the delivery communication code in the receiving device and/or the client device matches the delivery communication code in the delivery device. If at step 508 the delivery device is not able to establish a secure connection, then the delivery device returns with the one or more purchased items (step 506), with the operation ending thereafter.

If at step 508 the delivery device establishes a secure connection, the receiving device and/or the client device provide details to the delivery device as to an exact location of the receiving device (step 510). That is, the receiving device is at a location on the property associated with the address where the one or more physical items are to be delivered, the location being, for example, front of house, back of house, side next to garage, on a patio, or some other location on the property that is accessible by the delivery device. Thus, the receiving device and/or the client device guides the delivery device to the exact location of the receiving device.

In accordance with the illustrative embodiments, the receiving device is a secure device that is normally locked. Thus, the receiving device performs one or more actions to receive the one or more purchased physical items once secure communications are established with the delivery device (step 512). One example, the receiving device simply unlocks so that, if the delivery device is a handheld device used by a courier, the courier with the delivery device in hand, opens the receiving device, places the one or more purchased physical items inside the receiving device, and closes the receiving device. Once the receiving device is closed, the receiving device performs a locking action so as to securely hold the one or more purchased physical items. In another example, the receiving device unlocks and utilizes an opening mechanism to open so that the one or more purchased physical items may be placed inside, That is, if the delivery device is a drone, then once the receiving device unlocks and opens, the delivery device may drop or otherwise place the one or more purchased physical items inside.

Once the receiving device detects or is informed that the one or more purchased physical items are inside, the receiving device reverses the opening mechanism so that the receiving device closes and then performs a locking action so as to securely hold the one or more purchased physical items. In either example, the receiving device may utilize one or more sensors, cameras, or the like, to determine that the one or more purchased physical items have indeed been placed within the receiving device so as to protect the buyer from a fraudulent delivery as well as to protect the order fulfillment service (step 514). Once the receiving device completes the one or more actions to protect the one or more purchased physical items, the receiving device and/or the delivery device may confirm delivery of the one or more purchased physical items (step 516) and deactivate the delivery communication code associated with the one or more purchased physical items (step 518), with the operation ending thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, the illustrative embodiments provide mechanisms for secure automated parcel delivery mechanisms that address the problem of secure parcel delivery from retailers to recipients. Specifically, in the context of leveraging courier, drone, or similar types of parcel delivery mechanisms, the illustrative embodiments provide for secure automated parcel delivery through the use of a secure receiving device located at the recipient's location that allows for secure automated parcel delivery and either eliminates or greatly reduces having to return to the location if the recipients are not home, leaving a parcel at the location only for it to be absconded with by a thief, or the like. By either eliminating or greatly reducing these events, the secure automated parcel delivery mechanisms of the illustrative embodiments reduce associated costs and maximize retailers' profit.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable moderns and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

As used herein, the term “wirelessly communicating” means that there is at least one wireless segment, or link, in the communication path of a communication. There may be wire-based segments, or links, when a communication is wirelessly communicated.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving, by a first device owned and controlled by a recipient entity to whom a physical item is being delivered, a delivery communication code;
determining, by the recipient entity and through the first device, a delivery policy data set indicative of a manner in which the physical item is to be delivered;
detecting, by the first device, that the physical item is in the process of being delivered to a designated delivery zone where the physical item will be received by the recipient entity;
responsive to the detection that the physical item is being delivered, wirelessly authenticating the first device to a second device controlled by a sender entity using the delivery communication code; and
responsive to the authentication of the first device to the second device, wirelessly communicating, from the first device to the second device, the delivery policy data set.

2. The method of claim 1, wherein the first device receives the delivery communication code from a third device that is controlled by the sender entity.

3. The method of claim 1, wherein the delivery communication code further includes information indicative of the identity of the physical item.

4. The method of claim 1, wherein the manner in which the physical item is to be delivered is at least one of the following: address Where the one or more physical items are to be delivered, contact information if issues arise with completing the order, payment information to pay for the one or more physical items, a type of wireless communication to be used in delivery of the one or more physical items, a time window for delivery of the one or more physical items, an acknowledgement policy for receipt of the one or more physical items, or multiple addresses to receive different portions of the one or more physical items.

5. The method of claim 1, further comprising:
responsive to the authenticating the first device to the second device, wirelessly communicating, from the first device to the second device, providing details as to an exact location of the first device.

6. The method of claim 1, further comprising:
responsive to the authenticating the first device to the second device, unlocking, by the first device, for the physical item to be placed inside the first device; and
responsive to the physical item being placed inside the first device, securing, by the first device, the physical item. The method of claim 1, further comprising:
responsive to the authenticating the first device to the second device, unlocking, by the first device, for the physical item to be placed inside the first device;
opening, by the first device, for the physical item to be placed inside the first device;
responsive to detecting that the physical item is inside the first device, closing, by the first device, so as to secure the physical item; and
securing, by the first device, the physical item.

8. The method of claim 1, further comprising:
confirming, by the first device or the second device, delivery of the purchased item; and
deactivating, by the first device and the second device, the delivery communication code associated with the physical item.

9. The method of claim 1, wherein the delivery code is active for a given time period around an expected delivery time of the improved package for improved security and wherein the delivery code is active for securing communication between the second device and the first device when the second device is within a predetermined distance of the first device.

10. The method of claim 3, wherein the identity of the physical item is verified by leveraging various sensors and cameras.

11. A computer program product comprising a computer readable storage medium having a computer readable program stored therein, wherein the computer readable program, when executed on a computing device, causes the computing device to:
receive, by a first device owned and controlled by a recipient entity to whom a physical item is being delivered, a delivery communication code;
determine, by the recipient entity and through the first device, a delivery policy data set indicative of a manner in which the physical item is to be delivered;
detect, by the first device, that the physical item is in the process of being delivered to a designated delivery zone where the physical item will be received by the recipient entity;
responsive to the detection that the physical item is being delivered, wirelessly authenticate the first device to a second device controlled by a sender entity using the delivery communication code; and
responsive to the authentication of the first device to the second device, wirelessly communicate, from the first device to the second device, the delivery policy data set.

12. The computer program product of claim 11, wherein the first device receives the delivery communication code from a third device that is controlled by the sender entity.

13. The computer program product of claim 11, wherein the delivery communication code further includes information indicative of the identity of the physical item.

14. The computer program product of claim 11, wherein the manner in which the physical item is to be delivered is at least one of the following: address where the one or more physical items are to be delivered, contact information if issues arise with completing the order, payment information to pay for the one or more physical items, a type of wireless communication to be used in delivery of the one or more physical items, a time window for delivery of the one or more physical items, an acknowledgement policy for receipt of the one or more physical items, or multiple addresses to receive different portions of the one or more physical items.

15. The computer program product of claim 11, wherein the computer readable program further causes the computing device to:
responsive to the authenticating the first device to the second device, wirelessly communicate, from the first device to the second device, providing details as to an exact location of the first device.

16. The computer program product of claim 11, wherein the computer readable program further causes the computing device to:
responsive to the authenticating the first device to the second device, unlock, by the first device, for the physical item to be placed inside the first device; and
responsive to the physical item being placed inside the first device, secure, by the first device, the physical item.

17. The computer program product of claim 11, wherein the computer readable program further causes the computing device to:
responsive to the authenticating the first device to the second device, unlock, by the first device, for the physical item to be placed inside the first device;
open, by the first device, for the physical item to be placed inside the first device;
responsive to detecting that the physical item is inside the first device, close, by the first device, so as to secure the physical item; and
secure, by the first device, the physical item.

18. The computer program product of claim 11, wherein the computer readable program further causes the computing device to:
confirm, by the first device or the second device, delivery of the purchased item; and
deactivate, by the first device and the second device, the delivery communication code associated with the physical item.

19. The computer program product of claim 11, wherein the delivery code is active for a given time period around an expected delivery time of the improved package for improved security and wherein the delivery code is active for securing communication between the second device and the first device when the second device is within a predetermined distance of the first device.

20. An apparatus comprising:
at least one processor; and
at least one memory coupled to the at least one processor, wherein the at least one memory comprises instructions which, when executed by the at least one processor, cause the at least one processor to:
receive, by a first device owned and controlled by a recipient entity to whom a physical item is being delivered, a delivery communication code;
determine, by the recipient entity and through the first device, a delivery policy data set indicative of a manner in which the physical item is to be delivered;
detect that the physical item is in the process of being delivered to a designated delivery zone where the physical item will be received by the recipient entity;
responsive to the detection that the physical item is being delivered, wirelessly authenticate the first device to a second device controlled by a sender entity using the delivery communication code; and
responsive to the authentication of the first device to the second device, wirelessly communicate, from the first device to the second device, the delivery policy data set.
